(19) United States
(12) Patent Application Publication
(10) Pub. No.: US 2018/0022426 A1
(43) Pub. Date: Jan. 25, 2018

(54) PLATFORM DEVICE

(71) Applicant: Goetz SIEGMANN, Eriskirch (DE)

(72) Inventors: Goetz SIEGMANN, Eriskirch (DE); Thilo SEEGER, Ravensburg (DE)

(21) Appl. No.: 15/548,997

(22) PCT Filed: Feb. 6, 2015
(86) PCT No.: PCT/EP2015/052543

§ 371 Date: Aug. 4, 2017

(51) Int. Cl. B63B 35/44; F24J 2/52; F03D 13/25

(52) U.S. Cl. CPC B63B 35/44; F03D 13/25; F24J 2/5267; B63B 2035/446; B63B 2035/4453

(57) ABSTRACT

A platform device includes at least one floatable platform, which is provided for supporting at least one energy generating unit at least partially above a water level. The at least one floatable platform comprises a plurality of tubes providing a buoyant force and comprises a carrier structure, which is fastened to the tubes.

### STATE OF THE ART

The invention relates to a platform device according to the preamble of claim 1.

Platform devices with at least one floatable platform, which are provided for supporting at least one energy generating unit at least partially above a water level, have already been proposed.

### Advantages of the Invention

The invention is based on a platform device with at least one floatable platform, which is provided for supporting at least one energy generating unit at least partially above a water level.

It is proposed that the at least one floatable platform comprises a plurality of tubes providing a buoyant force and comprises a carrier structure, which is fastened to the tubes. Preferably the platform device has a main extension plane that extends parallel to the water level. Preferentially the tubes of the at least one floatable platform are connected to each other via the carrier structure. Advantageously the platform covers with its support surface a seawater surface. The platform advantageously covers a seawater surface of at least 0.5 km², preferably at least 1 km², preferentially more than 2 km² and particularly preferably more than 3 km². Preferentially the at least one floatable platform is provided for supporting at least one regenerative energy generating unit at least partially above a water level. Preferentially the at least one floatable platform is provided for bearing at least a wind power plant and/or at least a photovoltaic plant at least partially above a water level. This allows, for example, implementing a complementary energy production, as a result of which a continuous energy production is achievable. An arrangement of wind power plants and/or photovoltaic plants on the platform in the open sea may increase an efficiency of the wind power plants and/or photovoltaic plants, as on the open sea there are no or almost no obstacles slowing down the wind or casting shadows. By “supporting at least partially above a water level” is to be understood, in this context, in particular that the energy generating unit is held by the platform at least partially above the water level. “Provided” is to mean, in particular, specifically programmed, designed and/or equipped. By an object being provided for a certain function is to be understood, in particular, that the object fulfills and/or implements said certain function in at least one application state and/or operating state. Preliminary tests of environmental compatibility have shown that the platform device according to the invention results in a sustainable improvement of water quality and thus has a regenerative impact on the fish stocks.

By means of the implementation of the platform device according to the invention, a secure standing can be provided for the energy generating units in the sea. Furthermore, a high degree of stability of the platform device is achievable. Furthermore this allows making use of the sea location with its advantages, e.g. the huge usable areas, for producing energy. The platform device thus allows creating new opportunities of producing regenerative energy. Obtaining a permit for a construction of energy generating units, which in particular cause misgivings as regards aspects of aesthetics and of nature conservation, may be facilitated due to usage of sea areas, thus allowing easy power production.

It is also proposed that the platform device comprises at least one first anchorage unit, which is stationarily connected to the at least one floatable platform and comprises at least one anchor winch. “Stationarily connected” is to mean, in this context, in particular that the anchorage unit keeps to a position with respect to the platform while an orientation of the anchorage unit and/or of the anchor winches of the anchorage unit may be varied with respect to the platform. Furthermore, in this context, an “anchorage unit” is to be understood, in particular, as a unit that is provided to anchor the at least one floatable platform, in particular on a sea bottom. Preferably it is to be understood, in particular, as a unit that is provided for an at least partial fixation of the at least one floatable platform on a water surface. Particularly preferably the at least one floatable platform is held in a position or at least in a spatial region on a water surface via the anchorage unit. Moreover, an “anchor winch” is to be understood, in this context, in particular as a device provided for lifting and/or lowering an anchoring means. Preferably it is to be understood, in particular, as a device provided for adjusting an effective length of an anchoring means. Preferentially, by adjusting an effective length of an anchoring means in particular a distance between the anchorage unit and an anchor point can be modified via the anchor winch. Particularly preferentially, for example, a change of a water depth may be compensated via the anchor winch. Preferably the anchor winch comprises at least one drive unit, by which the anchoring means can be lifted and/or lowered. Herein an “anchoring means” is to be understood, in particular, as a connection element, e.g. an anchor chain, an anchor cable and/or a spring steel strip, for the purpose of connecting the anchorage unit to an anchor point. Furthermore, an “effective length” is herein to be understood, in particular, as a length of the anchoring means that is effectively used at an actual moment, i.e. not counting a wound-up and/or otherwise unused portion of the anchoring means. In this an “anchor point” is to be understood as a fixation point of a bottom anchorage for fixating the anchor means. Herein a “bottom anchorage” is to be understood, in particular, as a portion of the anchorage that is rigid with respect to an environment, in particular to a bottom. It is preferably to be understood, in particular, as an anchorage that is arranged on a sea bottom. This allows providing in particular an especially advantageous anchorage of the platform device. It allows in particular an especially variable anchorage. Moreover a particularly reliable anchorage is achievable.

It is further proposed that the platform device comprises at least one second anchorage unit, which is stationarily connected to the at least one floatable platform and comprises at least one anchor winch. Preferably the first anchorage unit and the second anchorage unit are embodied spatially separate from one another. Particularly preferably the first anchorage unit and the second anchorage unit are arranged, with respect to a center of the at least one floatable platform, on different sides of the platform. This allows in particular an especially advantageous anchorage of the platform device. It further allows an especially variable anchorage. Moreover a particularly reliable anchorage is achievable.

It is furthermore proposed that the at least one anchorage unit comprises at least two anchor winches, which are connected to at least two anchor points that are embodied spatially separate from each other. The at least one anchorage unit can be implemented by the at least one first anchorage unit as well as by the at least one second anchorage unit as well as by the at least one first anchorage unit and the at least one second anchorage unit. Preferably the at least one anchorage unit comprises at least three anchor winches, which are connected to at least three anchor points that are embodied spatially separate from each other. Preferentially the first anchorage unit and the second anchorage unit each comprise at least three anchor winches. Preferably the anchor winches of a respective anchorage unit are connected to at least three anchor points that are embodied spatially separate from each other. Anchor winches of different anchorage units may principally also be connected to the same anchor point. Particularly preferably the anchor winches of the anchorage units are connected to in total at least four anchor points that are embodied spatially separate from each other. As a result of this, in particular an advantageously high degree of anchoring stability is achievable. Furthermore an advantageous load distribution is achievable.

It is further proposed that the at least one anchor winch of the at least one anchorage unit is supported rotatably with respect to the at least one floatable platform. Preferably the at least one anchor winch of the at least one anchorage unit is supported in such a way that it is rotatable about its own axis. Preferably the at least one anchor winch of the at least one anchorage unit is arranged on a ring mount. Preferentially the at least one anchor winch of the at least one anchorage unit is stationarily arranged on the at least one floatable platform and is rotatable in its position. Particularly preferably the at least one anchor winch of the at least one anchorage unit is supported in such a way that it is rotatable about a rotary axis, perpendicularly to a main extension plane of the platform device. A “main extension plane” of a structural unit is to be understood, in particular, as a plane that is parallel to a greatest lateral face of a smallest geometrical cuboid that just still entirely encompasses the structural unit and that in particular extends through the center point of the cuboid. Preferentially the at least one anchor winch of the at least one first anchorage unit and the at least one anchor winch of the at least one second anchorage unit are supported in such a way that they are rotatable with respect to the at least one floatable platform. This allows in particular providing an especially advantageous anchorage of the platform device. Furthermore it is thus advantageously achievable that the at least one anchor winch may orientate itself at least partially in a pull direction to an anchor point and/or to a bottom anchorage. In particular, twisting of an anchoring means can be prevented.

Moreover it is proposed that the at least one anchor winch of the at least one anchorage unit is connected to an anchor point via a spring steel strip. Preferably the platform device comprises the at least one spring steel strip via which the at least one anchor winch of the at least one anchorage unit is connected to an anchor point. Preferentially the spring steel strip is implemented by a non-corroding spring steel strip. Preferably the anchor winches of the at least one first anchorage unit and the at least one second anchorage unit are connected to respectively one anchor point via a spring steel strip. By a “spring steel strip” is to be understood, in this context, in particular a strip-shaped anchoring means that is made of a spring steel. Preferably it is to be understood, in particular, as an anchoring means that has, if viewed in a section plane perpendicular to a main extension direction, a width that is substantially greater than a height of the anchoring means. Herein “substantially greater” is to mean, in particular, that a value is greater by at least 10 times, preferably at least 25 times and particularly preferably at least 100 times. An exemplary measurement of the spring steel strip could be, for example, 2.5 mm×600 mm if viewed in a sectional plane perpendicular to a main extension direction. A “main extension direction” of a structural unit is to be understood, in particular, as a direction extending parallel to a greatest lateral edge of a smallest geometrical cuboid that just still entirely encompasses the structural unit. This allows in particular providing a particularly reliable anchoring means. Preferentially in particular an anchoring means can thus be provided, which can be rolled up especially easily and evenly. Moreover this allows an advantageously space-saving roll-up.

It is also proposed that the at least one anchor winch of the at least one anchorage unit comprises at least one anchor wheel, on which the spring steel strip can be wound at least partially. Preferably a distance between the anchor winch and the anchor point can be changed by winding and/or unwinding the spring steel strip. The anchor wheel preferably has a width that at least approximately equals a width of the spring steel strip. This may allow a particularly even winding. Preferentially this allows preventing an undesired hook-up of the anchoring means. By an “anchor wheel” is to be understood, in this context, in particular a wheel-shaped component of the anchor winch, which is preferably drivable via a drive unit of the anchor winch. Preferably it is to be understood as a wheel-shaped component, which is in at least one state provided for partially receiving the spring steel strip, in particular in a wound state. Preferentially the spring steel strip can be wound on the anchor wheel. Especially preferentially the spring steel strip is firmly fixated to the anchor wheel with one end. This allows reliably adjusting an effective length of the spring steel strip. Furthermore an advantageous anchor winch can be provided. Preferentially in this way in particular an anchoring means can be rolled up and/or off in a particularly easy and even fashion. Moreover an advantageously space-saving roll-up can be rendered possible.

It is further proposed that the platform device comprises a sun position tracking-turning unit, which is provided for an at least partial sun position tracking and rotating of the at least one floatable platform. Preferably the at least one floatable platform may be rotated via the sun position tracking-turning unit in an angle range of at least 100°, preferably at least 110° and particularly preferably at least approximately 120°. Preferentially rotating the at least one floatable platform is effected about a rotary axis that is perpendicular to a main extension plane of the at least one floatable platform. A “sun position tracking-turning unit” is to be understood, in this context, in particular as a unit which is provided for automatically rotating the at least one floatable platform depending on an actual sun position. Preferably it is to be understood as a unit which is provided to orient an energy generating unit borne by the at least one floatable platform with respect to a sun. Preferentially the sun position tracking-turning unit is provided to orient an energy generating unit that is implemented as a photovoltaic plant with respect to a sun. Herein an orientation with respect to the sun may be effected based on a time of day or a time of the year as well as by means of a sensor. If a sensor is used, in particular unnecessary rotating, e.g. in case of bad weather, may be avoided. This may allow an automatic sun position tracking and rotating. Preferably in this way an advantageously high efficiency rate of the energy generating unit is achievable.

It is also proposed that the sun position tracking-turning unit that is intended for rotating the at least one floatable platform is provided for actuating the at least one anchor winch of the at least one anchorage unit. Preferably the sun position tracking-turning unit that is intended for rotating the at least one floatable platform is provided for actuating the anchor winches of the first anchorage unit and of the second anchorage unit. Preferentially a rotation is implemented by winding and/or unwinding the spring steel strips on the anchor wheels of the anchor winches. In this way an anchorage may advantageously be used for a sun position tracking and rotating of the at least one floatable platform. This furthermore allows a reliable rotating. Moreover additional drive units for a sun position tracking and rotating may be dispensed with.

It is further proposed that the tubes of the at least one floatable platform each comprise at least three spigots, which are embodied in a one-part implementation with a base body of the tube and are respectively provided for receiving a fastening element. Preferably at least one fastening element can be fastened to the tube via the spigots. Preferentially the at least one fastening element can be fastened to at least one of the spigots. The base body of the tube preferably has a hollow-cylindrical shape. Preferentially the base body implements a base shape of the tube. Preferably the spigots are extruded onto the base body of the tube. Preferentially the spigots are arranged on a circumferential surface of the base body. Particularly preferably, if viewed in a circumferential direction of the base body, the spigots are distributed evenly on a circumferential surface of the base body. Preferentially the tubes of the at least one floatable platform each comprise four spigots, which are embodied in a one-part implementation with a base body of the tube and are respectively provided to receive a fastening element. A “spigot” is to be understood, in this context, in particular as an extension of a component which is provided to connect the component to a further component. By a “one-part implementation” is to be understood, in particular, connected at least by substance-to-substance bond, e.g. by a welding process, an adhesive bonding, an injection molding process and/or by another process that is deemed expedient by a person skilled in the art, and/or advantageously formed in one piece, e.g. by a production of one cast and/or by a production in a one-component or multi-component injection molding procedure and advantageously of one individual blank. By means of an appropriate fastening a wear-down may be kept advantageously low. Furthermore this allows, in particular, creating a fastening opportunity which is preferably not influenced by the length of the tube changing due to temperature. Moreover in this way in particular a fastening opportunity may be created which preferably is not influenced by a lability of the floatable platform.

Moreover it is proposed that the carrier structure, which is at least partially fastened to the fastening elements, is at least partially implemented by trapezoid profiles. Preferentially the trapezoid profiles are embodied as regular steel trapezoid profiles. By a “trapezoid profile” is to be understood, in this context, in particular a profile which, if viewed in a sectional plane perpendicular to a longitudinal extension, has an at least approximately trapezoidal cross section. Preferably it is to be understood, in particular, as a profile which, if viewed in a sectional plane perpendicular to a longitudinal extension, has three main edges that are adjacent to each other, wherein two inner angles facing each other between respectively two of the main edges are respectively more than 90° and particularly preferably less than 170°. Particularly preferably the two inner angles facing each other between respectively two of the main edges are at least approximately identical. Preferentially, if viewed in a sectional plane perpendicular to a longitudinal extension, the trapezoid profile has a cross section that is open towards a side and is at least approximately trapezoid-shaped. Preferentially the cross section of the trapezoid profile comprises only three sides of a profile. Principally it would be conceivable that at least one of the main edges is implemented as an edge that is averaged on several short edges. Using trapezoid profiles advantageously allows rendering a profile available that absorbs high normal forces and low torsion tensions. As a result of this, a soft carrier structure, in particular dispensing with wear parts, can be rendered available.

It is also proposed that the at least one floatable platform comprises in a peripheral edge region a breakwater device with at least one structural element that is arranged below a water surface and is provided for delaying a wave. Preferably the at least one structural element of the breakwater device is arranged at a defined depth below the water level. Preferably the at least one breakwater device reduces the wave impact in a direction of a geometric center of the platform. Advantageously the at least one breakwater device reduces the wave impact in this direction to a defined value that is less than 80% of an original wave impact, especially advantageously less than 60% of the original wave impact and very particularly advantageously less than 30% of the original wave impact. A “breakwater device” is to be understood, in this context, in particular as a device that is provided to reduce a wave impact within the peripheral edge region to a defined value. Preferably a wave impact is reduced to a defined value by breaking the wave. Herein a “wave impact” is to be understood, in particular, as a change of a support surface of the platform caused by a swell and thus a change of a position and/or orientation of the energy generating units. Advantageously the platform covers with its support surface a sea water surface. Furthermore, in this context a “structural element” is to be understood, in particular, as an element having a macroscopic surface structure at least in a partial region. By a “macroscopic surface structure” is to be understood, in this context, in particular a surface structure having bumps and/or deepenings extending beyond a base shape of a body. Preferably the bumps and/or deepenings have a height and/or depth of at least 0.1 cm, preferably at least 1 cm, preferentially at least 2 cm and particularly preferably at least 5 cm, in particular if viewed perpendicularly to a surface of the base shape of a body. By a “defined depth” is to be understood, in particular, an average distance between a longitudinal axis of the wave absorption element and the water level caused by the actual load. By an “original wave impact” is to be understood, in particular, a wave impact before hitting on the platform, i.e. at a multilateral peripheral edge of the platform. By the breakwater device a region, e.g. the peripheral edge region, can be provided on a sea in which there is less wave impact than in the open sea. This allows providing a secure standing for the energy generating units in the sea, as a result of which the sea location with its advantages, e.g. the huge usable areas, can be utilized for producing energy.

Moreover it is proposed that the at least one structural element of the breakwater device is embodied as a trapezoidal sheet. This allows in particular providing an especially robust structural element. Furthermore, in this way a wave impact can be at least reduced in a reliable fashion. Preferably thus in particular an advantageous delay of a wave can be achieved below the water surface, as a result of which a wave is induced to turn over. Principally, however, it would also be conceivable implementing a structural element differently from a trapezoidal sheet. A variety of implementations of the structural element are conceivable which would be deemed expedient by a person skilled in the art, for example as a corrugated sheet.

Furthermore it is proposed that the breakwater device comprises at least one first structural element arranged in an outer peripheral edge region and comprises at least one second structural element arranged at a substantially smaller depth below a water surface than the first structural element and arranged in an inner peripheral edge region. Preferably the structural elements are embodied at least substantially identical. If viewed in a direction from a sea-side peripheral edge of the platform toward the geometric center of the platform, the inner peripheral edge region preferably directly adjoins the outer peripheral edge region. Preferentially, if viewed in a main extension plane of the platform, the inner peripheral edge region is encompassed by the outer peripheral edge region. The outer peripheral edge region preferably directly abuts on the sea-side peripheral edge. By a “substantially smaller depth” is to be understood, in this context, in particular that a value of an average depth of the at least one second structural element corresponds to maximally 80%, preferably maximally 65% and especially preferentially maximally 50% of a value of an average depth of the at least one first structural element. As a result of this, a wave impact may be at least reduced in a particularly reliable fashion. Preferably in this way in particular an advantageous delay of a smaller wave, which has already been broken by the at least one first structural element, is achievable below a water surface. This advantageously allows breaking of small waves as well.

It is also proposed that at least a portion of the tubes of the at least one floatable platform is embodied as semi-sinkers, implementing a portion of the breakwater device of the at least one floatable platform. A “semi-sinker” is to be understood, in this context, in particular as a buoyant body, the total volume of which is pressed, in an expedient state, below a water surface by a load impact by at least 50%, preferably at least 60%, preferentially at least 70% and particularly preferably at least 80%. This advantageously allows preventing waves breaking against the tubes. Preferably this allows, in particular, achieving that waves flow over the tubes and while flowing over are delayed due to friction on an upper side of the tube.

The invention is further based on a method for operating a platform device. It is proposed that the at least one floatable platform is rotated via the sun position tracking-turning unit at least partially with respect to a sun position by means of the at least one anchorage unit. This allows an automatic sun position tracking and rotating. Preferably in this way an advantageously high efficiency rate of the energy generating unit is achievable. Furthermore this may allow a reliable rotating of the at least one floatable platform.

Moreover it is proposed that the breakwater device induces a delay of waves hitting on the platform device, at least in a peripheral edge region of the floatable platform. By means of the breakwater device a region, e.g. the peripheral edge region, can be provided on a sea in which there is less wave impact as compared to the open sea. This allows providing a secure standing for the energy generating units on the sea, as a result of which the sea location with its advantages, e.g. the huge usable areas, can be utilized for energy production.

The platform device according to the invention is herein not to be restricted to the application and implementation form described above. In particular, for fulfilling a functionality herein described, the platform device according to the invention may comprise a number of respective elements, components and units that differs from a number herein mentioned.

### DRAWINGS

Further advantages may be gathered from the following description of the drawings. In the drawings three exemplary embodiments of the invention are presented. The drawings, the description and the claims contain a plurality of features in combination. The person having ordinary skill in the art will purposefully also consider the features separately and will find further expedient combinations.

It is shown in:

FIG. 1 a platform device with a floatable platform, with an energy generating unit, with a first anchorage unit and with a second anchorage unit in a schematic view from above,

FIG. 2 the platform device in different rotary positions in a schematic view from above,

FIG. 3 a partial section III of the platform device with a breakwater device in a schematic view from above,

FIG. 4 the partial section III of the platform device with the breakwater device in a schematic sectional view,

FIG. 5 a partial section V of the platform device with the first anchorage unit, which has three anchor winches, in a schematic view from above,

FIG. 6 a detail view VI of the first anchor winch of the first anchorage unit, in a schematic view from above,

FIG. 7 the detail view VI of the first anchor winch of the first anchorage unit, in a schematic sectional view,

FIG. 8 a partial section of the platform device with the floatable platform, which has several tubes providing a buoyant force and has a carrier structure, and a service boat, in a schematic sectional view,

FIG. 9 a trapezoid profile of the carrier structure in a schematic sectional view along the section line IX,

FIG. 10 a detail view X of one of the tubes of the platform, in a schematic sectional view,

FIG. 11 one of the tubes of the platform, in a schematic sectional view along the section line XI,

FIG. 12 a photovoltaic module of the energy generating unit of the platform device, in a schematic view from above,

FIG. 13 a detail view XIII of a cooling unit of the energy generating unit, in a schematic sectional view,

FIG. 14 a bottom anchorage of the platform device, in a schematic view,

FIG. 15 the bottom anchorage of the platform device, in a schematic sectional view along the section line XV,

FIG. 16 the bottom anchorage of the platform device, in a schematic sectional view along the section line XVI,

FIG. 17 an alternative bottom anchorage of the platform device, in a schematic lateral view,

FIG. 18 the alternative bottom anchorage of the platform device, in a schematic view from above, and

FIG. 19 a partial section of a further alternative bottom anchorage of the platform device, in a schematic sectional view.

### DESCRIPTION OF THE EXEMPLARY EMBODIMENTS

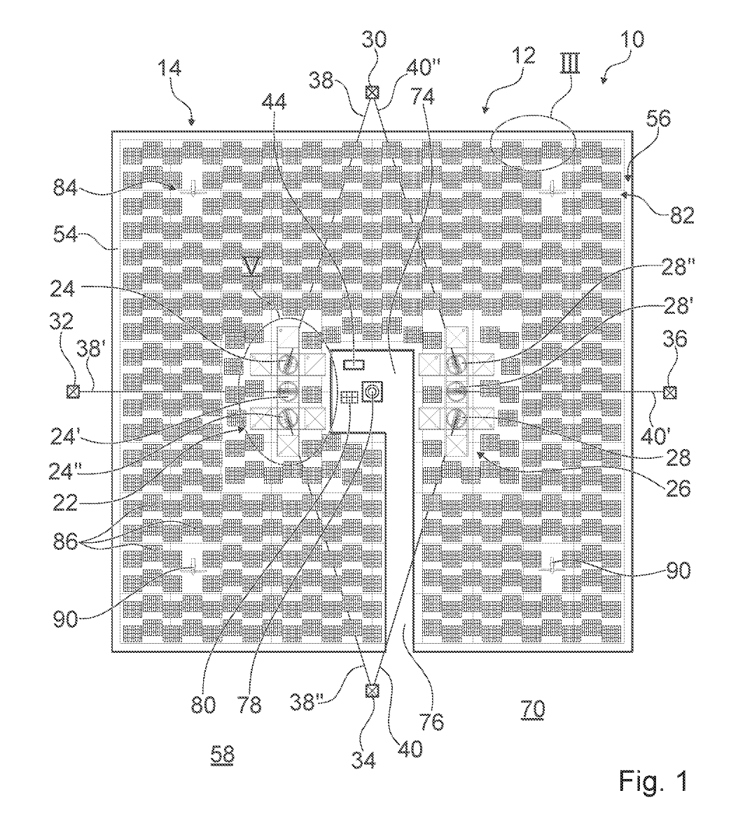

FIGS. 1 to 13 show an exemplary embodiment of a platform device 10 according to the invention. In FIG. 1 the entire platform device 10 is schematically depicted in a view from above. The platform device 10 is arranged on a sea 70. The platform device 10 is anchored on a sea bottom 72 in a distance of more than 70 km off a coast. Principally, however, another distance from a coast, which is deemed expedient by a person skilled in the art, would also be conceivable. The platform device 10 can principally be anchored near a coast or in international waters, independently from water depths. Locations with an annual insulation of more than 2,000 sun hours are preferable. In this exemplary embodiment the platform device 10 has a square shape. Principally, however, another shape deemed expedient by a person skilled in the art would also be conceivable, e.g. a round or triangular shape. The platform device 10 produces regenerative energy. The platform device 10 is embodied as an anchored floating platform. The platform device 10 is embodied as an anchored floating solar platform.

The platform device 10 comprises a floatable platform 12. The platform 12 is provided to support an energy generating unit 14 above a water level 16. The energy generating unit 14 forms a portion of the platform device 10. The platform 12 covers with its support surface a portion of a sea surface. The platform 12 has an edge length of approximately 1,000 m. Principally, however, another edge length deemed expedient by a person skilled in the art would also be conceivable. However, edge lengths of 1,000 m to 2,000 m are preferable.

For supply and removal the platform device 10 comprises a port 74. The port 74 is implemented by a seawater surface left free within the platform 12. The port 74 is arranged in a center of the platform 12. For reaching the port 74 the platform device 10 comprises an access channel 76 extending from a peripheral edge of the platform 12 to the port 74. The access channel 76 is also implemented by a seawater surface left free within the platform 12. In the port 74 there is a submarine cable 78 located with an associated power processing. The submarine cable 78 is connected to the energy generating unit 14 in a fashion that is not visible in detail. The submarine cable 78 is provided to transmit electric power to a transfer station on a coast. The submarine cable 78 extends below a sea level 16, preferably at least near a sea bottom 72. In the port 74 there are furthermore staff quarters 80 as well as landing piers for boats and/or ships, which are not shown in detail.

The energy generating unit 14 is embodied as a regenerative energy generating unit. The energy generating unit 14 comprises a photovoltaic plant 82. Furthermore the energy generating unit 14 comprises a wind power plant 84. It would, however, also be conceivable that the energy generating unit 14 comprises only a photovoltaic plant 82, only a wind power plant 84 and/or other energy generating plants, in particular regenerative energy generating plants that are deemed expedient by a person skilled in the art. The photovoltaic plant 82 and the wind power plant 84 of the energy generating unit 14 are partially complementary to each other, i.e. the photovoltaic plant 82 and the wind power plant 84 complement each other partially.

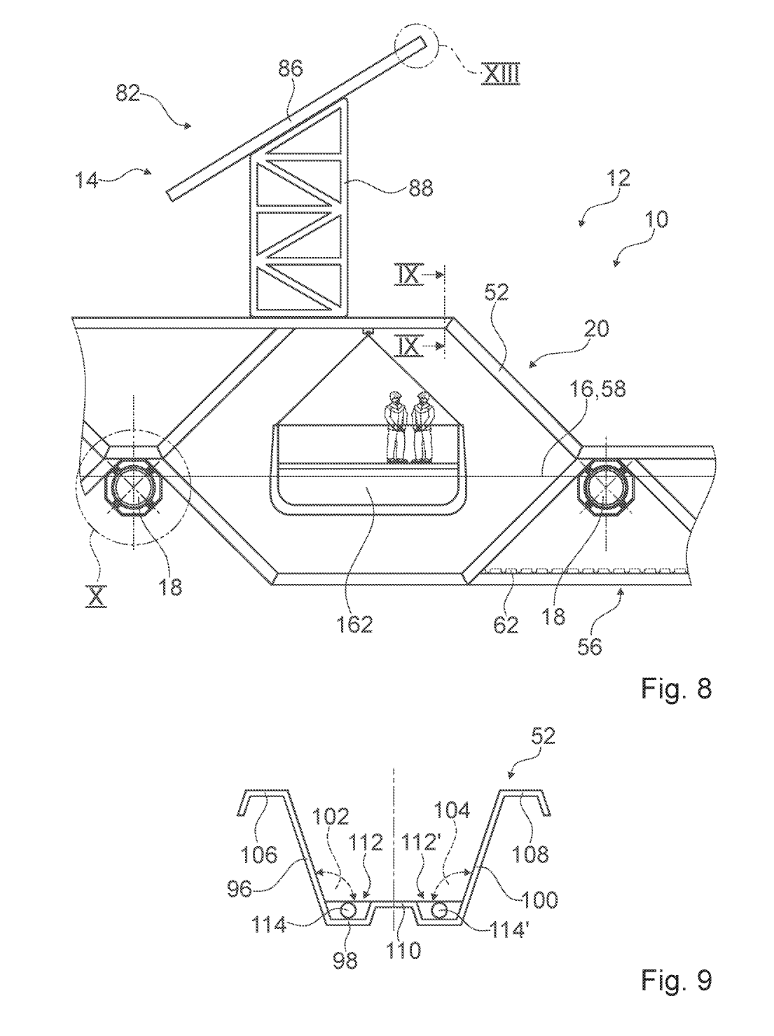

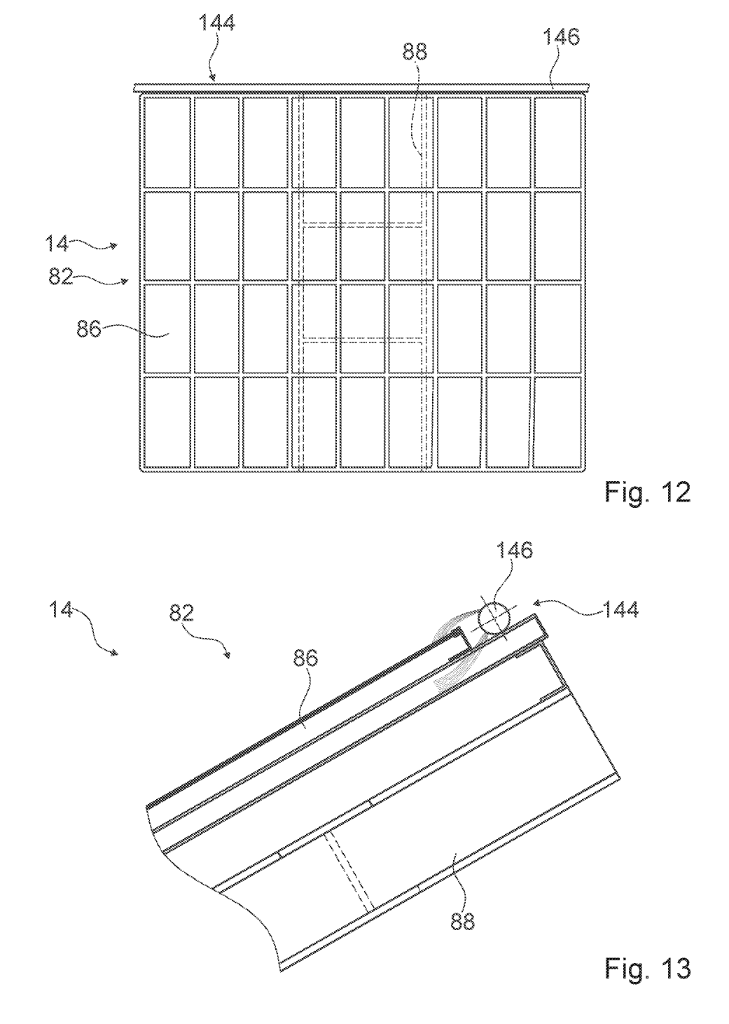

The photovoltaic plant 82 comprises a plurality of photovoltaic modules 86. The photovoltaic modules 86 are each mounted on the platform 12 via a mounting 88. The mounting 88 is substantially constructed from L-profiles. The mounting 88 is moreover held between two L-profiles, which are fastened on a carrier structure 20 of the platform 12. The L-profiles extend in parallel to tubes 18 of the platform 12. The photovoltaic modules 86 have a nano coating on a surface. Furthermore the photovoltaic modules 86 are respectively composed of a plurality of individual modules. The individual modules preferably have a size of 1.956 m by 0.941 m. The photovoltaic modules 86 each have a size of 9.75 m by 8.46 m. Principally, however, other sizes would also be conceivable. An optimum inclination angle of the photovoltaic modules 86 is specific of a location (FIGS. 8, 12).

The photovoltaic plant 82 further comprises a cooling unit 144. The cooling unit 144 pumps, for cooling the photovoltaic modules 86, seawater out of an expedient depth into a pipe 146, which extends at an upper end horizontally at an upper edge of the photovoltaic modules 86. For pumping the seawater the cooling unit 144 comprises a submersible pump having a CU sieve. The horizontally extending portion of the pipe 146 has a lower bore above each crimp. A size of the bores is herein selected in such a way that at least approximately equal water quantities leave at the beginning and at the end of the pipe 146. The water leaving out of the lower bores herein flows along and underneath the photovoltaic modules 86. In this evaporation generates chill, as a result of which the photovoltaic modules 86 are cooled due to the favorable convection. Moreover, as soon as the first power is generated in the morning, the pumping rate is increased in such a way that seawater leaves, in addition to the lower bores, out of upper bores of the pipe 146 and is sprayed onto the photovoltaic modules 86. Thus the photovoltaic modules 86 can be cleaned every day. Moreover the cooling unit 144 can also be used for cleaning (FIGS. 8, 13).

Furthermore a bird defense is provided, which is not shown in detail. This is because, if young fish particularly like it between the tubes 18 of the platform 12, in particular due to vegetal cover, depth water of the cooling unit 144, oxygen from dripping cooling water, shadow from the modules and fresh seawater after rotating, seabirds will arrive as well. These may principally be allowed to land anywhere on the platform device 10 but not on the energy generating unit 14. In particular, as the best of cleaning installations is not able to flush away the excreta when dried. It is hence necessary to install an electric wire on the topmost pipe 146 of the cooling unit 144. Principally, however, another bird defense deemed expedient by a person skilled in the art would also be conceivable, e.g. a pigeon-defense barbed-wire strip.

There are locations where not only a lot of sunny days occur but also wind with more than 8.0 m/s/a. As there is no substantial sea motion towards a geometrical center of the platform 12, the wind power plant 84 may be installed there, independently from the sea depth. The wind power plant 84 comprises a plurality of windwheels 90. The windwheels 90 are positioned on the platform 12 between the photovoltaic modules 86 of the photovoltaic plant 82. The windwheels 90 are herein positioned in such a way that a shadow is respectively cast in a region that has no photovoltaic modules 86 (FIG. 1).

As in case of sun shine and thus of a cloudless sky there is usually no wind and hence the photovoltaic plant 82 is generating energy, and in case of an overcast sky and hence substantially missing sunshine the wind power plant 84 generates energy, the platform device 10 usually produces regenerative energy continuously. The photovoltaic plant 82 and the wind power plant 84 are thus complementary to each other.

As there is enough space on the sea 70, the platform device 10 can be arranged in any desired number, in such a way that huge wave-free areas are created. These may be used as ports, for power reservoirs (P. to G. reservoirs), for tourism, for fish farming, for desalination plants etc. Outside territorial waters countries may produce and, for example, transform into gas, photovoltaic power, even if said countries have no access to the sea, e.g. Switzerland, Austria etc.

The floatable platform 12 comprises a plurality of tubes 18 providing a buoyant force. Furthermore the platform 12 comprises a carrier structure 20, which is fastened to the tubes 18. The tubes 18 are respectively embodied as a PP tube. The tubes 18 have a guaranteed service life of 100 years. The tubes 18 are respectively embodied as a Polypropylene tube. The tubes 18 are respectively arranged parallel to each other. The tubes 18 are respectively arranged in several rows that are distributed all over the entire platform 12 and extend across the entire platform 12. The tubes 18 of a row are respectively welded with each other. Additionally a respective safety bulkhead 92 is welded into a connection zone between the tubes 18 of a row. The safety bulkheads 92 are each pot-shaped. Via the safety bulkheads 92 respective inner hollow spaces 94 of adjacent tubes 18 are separated from each other. A welding of the tubes 18 while mounting a platform 12 is usually carried out on the coast, in particular according to the PP tube manufacturers' instructions. It would, however, also be conceivable that the tubes 18 are, for example, welded on a boat (FIGS. 8, 11).

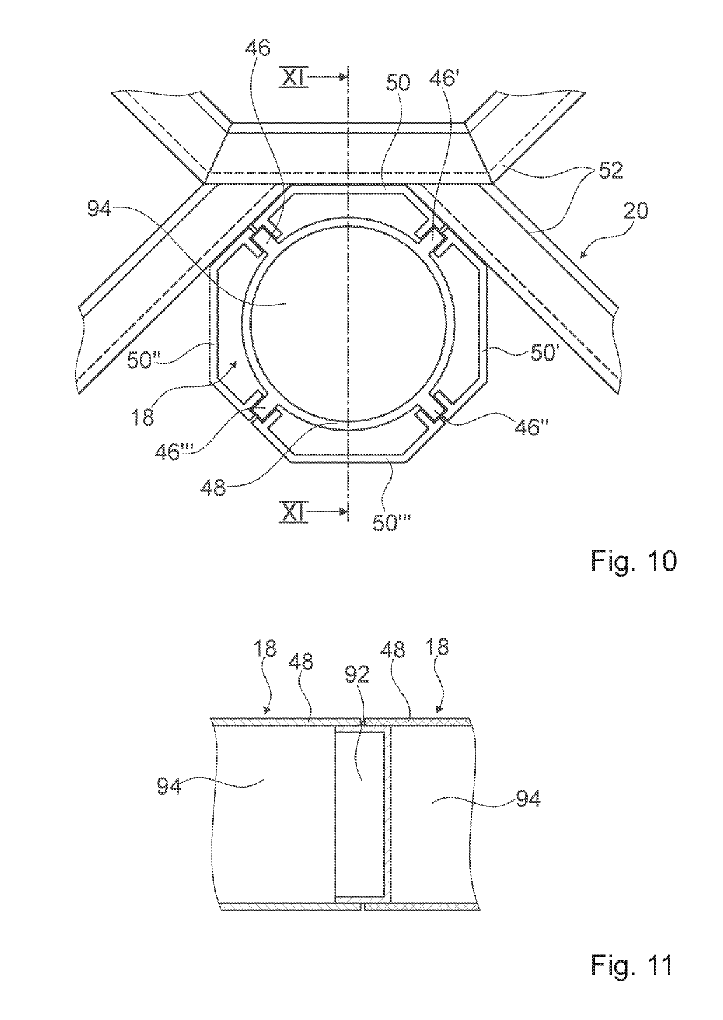

The tubes 18 of the floatable platform 12 each comprise four spigots 46, 46′, 46″, 46′″. Furthermore the tubes 18 each have a hollow-cylindrical base body 48. The base bodies 48 respectively form a base shape of the tube 18. The four spigots 46, 46′, 46″, 46′″ of a tube 18 are embodied in a one-part implementation with the base base body 48 of the tube 18. The four spigots 46, 46′, 46″, 46′″ of a tube 18 are respectively extruded onto the base body 48 of the corresponding tube 18. The spigots 46, 46′, 46″, 46′″ respectively protrude from the base body 48 of the corresponding tube 18 in a radial direction. The spigots 46, 46′, 46″, 46′″ are respectively arranged on a circumferential surface of the base body 48 of the corresponding tube 18. The spigots 46, 46′, 46″, 46′″ are furthermore evenly distributed on a circumferential surface of the base body 48 of the corresponding tube 18, if viewed in a circumferential direction of the base body 48 of the corresponding tube 18. The four spigots 46, 46′, 46″, 46′″ of a tube 18 are provided to receive fastening elements 50, 50′, 50″, 50′″. Fastening elements 50, 50′, 50″, 50′″ can be fastened to the corresponding tube 18 via the spigots 46, 46′, 46″, 46′″. For this purpose, the fastening elements 50, 50′, 50″, 50′″ can be fastened to the spigots 46, 46′, 46″, 46′″. The fastening elements 50, 50′, 50″, 50′″ are for this purpose fastened between respectively two spigots 46, 46′, 46″, 46′″ that are adjacent to each other in the circumferential direction. The fastening elements 50, 50′, 50″, 50′″ are respectively screwed through the spigots 46, 46′, 46″, 46′″. The fastening elements 50, 50′, 50″, 50′″ each embody a connection part between the tubes 18 and load inputs, in particular of the carrier structure 20. The fastening elements 50, 50′, 50″, 50′″ are each implemented by regular molded parts made of zincked steel. Respectively four of the fastening elements 50, 50′, 50″, 50′″ form a group, which implements at a respective tube 18 an eight-faced mantling in a radial direction. The four fastening elements 50, 50′, 50″, 50′″ of a tube 18 form a mantling of the tube 18, which has eight planar outer surfaces in a radial direction. The outer surfaces completely encompass the tube 18 in a region of the fastening elements 50, 50′, 50″, 50′″. Successive outer surfaces of the fastening elements 50, 50′, 50″, 50′″ are respectively tilted to each other in a circumferential direction in a 45° angle. The carrier structure 20 may advantageously be set upon this eight-faced mantling. An upper outer surface of a group of fastening elements 50, 50′, 50″, 50′″ is respectively oriented horizontally. The carrier structure 20 in a mounted state usually abuts on three outer surfaces of the groups of fastening elements 50, 50′, 50″, 50′″ which outer surfaces are adjacent to each other. In a mounted state the carrier structure 20 usually lies upon the three upwards-oriented outer surfaces of the groups of fastening elements 50, 50′, 50″, 50′″ and is fastened thereto (FIGS. 8, 10).

The carrier structure 20, which is partially fastened to the fastening elements 50, 50′, 50″, 50′″, is partially composed of trapezoid profiles 52. Due to a structure of the carrier structure 20, service boats 162 can get to almost any point of the platform 12 underneath the energy generating unit 14. The carrier structure 20 is substantially constructed of trapezoid profiles 52. The trapezoid profiles 52 of the carrier structure 20 are made of hot zinc dipped steel. The trapezoid profiles 52 hence have a guaranteed service life of 50 years. The trapezoid profiles 52 of the carrier structure 20 have an identical cross section. The trapezoid profiles 52 merely differ in length. The trapezoid profiles 52 have a constant cross section along a longitudinal extension. A cross section of the trapezoid profiles 52 is in the following described, as an example, by way of one of the trapezoid profiles 52. A description can however also be applied to the other trapezoid profiles 52 (FIG. 8).

The trapezoid profile 52 has, viewed in a sectional plane perpendicularly to a longitudinal extension, an approximately trapezoidal cross section. The trapezoid profile 52 has an open cross section. The trapezoid profile 52 comprises, viewed in the sectional plane perpendicularly to a longitudinal extension, three main webs 96, 98, 100, which are adjacent to each other. The main webs 96, 98, 100 of the trapezoid profile 52 are respectively connected to each other in a one-part implementation. The main webs 96, 98, 100 are bent of one piece. A middle main web 98 is connected to the two further main webs 96, 100. Two internal angles 102, 104 facing each other between the middle main web 98 and respectively one of the two further main webs 96, 100 each have a value of more than 90° and less than 170°. The internal angles 102, 104 each have a value of approximately 110°. The two internal angles 102, 104 are implemented identical. At ends of the two further main webs 96, 100 that face away from the middle main web 98, there is arranged respectively one approximately L-shaped, outwards-oriented end web 106, 108. The end webs 106, 108 respectively abut on one of the two further main webs 96, 100 in an angle of approximately 110°, on account of which the end webs 106, 108 extend at least approximately parallel to the middle main web 98. The end webs 106, 108 are respectively connected to one of the two further main webs 96, 100 in a one-part implementation. The ends of the end webs 106, 108 are each angled off by an internal angle of approximately 110° towards one of the further main webs 96, 100. The middle main web 98 comprises in a center region a bump 110. Between the bump 110 and the further main webs 96, 100, on both sides of the bump 110 respectively one channel 112, 112′ is formed, which serves for receiving supply lines 114, 114′ (FIGS. 8, 9).

The carrier structure 20 moreover comprises cross connections (not shown in detail) between the trapezoid profiles 52, which are provided to prevent a carrier tilting. The cross connections, which are not shown in detail, further serve as horizontal stiffeners. The cross connections are partially used for fastening the mountings 88 of the photovoltaic modules 86.

Furthermore the platform device 10 comprises a first anchorage unit 22, which is stationarily connected to the floatable platform 12. The platform device 10 further comprises a second anchorage unit 26, which is stationarily connected to the floatable platform 12. The first anchorage unit 22 and the second anchorage unit 26 are respectively arranged on the platform 12 on opposite sides of the port 74. The first anchorage unit 22 and the second anchorage unit 26 are respectively arranged near the port 74. The first anchorage unit 22 and the second anchorage unit 26 are respectively arranged nearer to a geometric center of the platform 12 than to the peripheral edge region 54. Moreover the first anchorage unit 22 is implemented in such a way that it is at least in a base position symmetrical to the second anchorage unit 26 with respect to a plane extending through the geometric center of the platform 12. The first anchorage unit 22 is implemented in such a way that it is at least in a base position centrally symmetrical to the second anchorage unit 26 with respect to the geometric center of the platform 12 (FIG. 1).

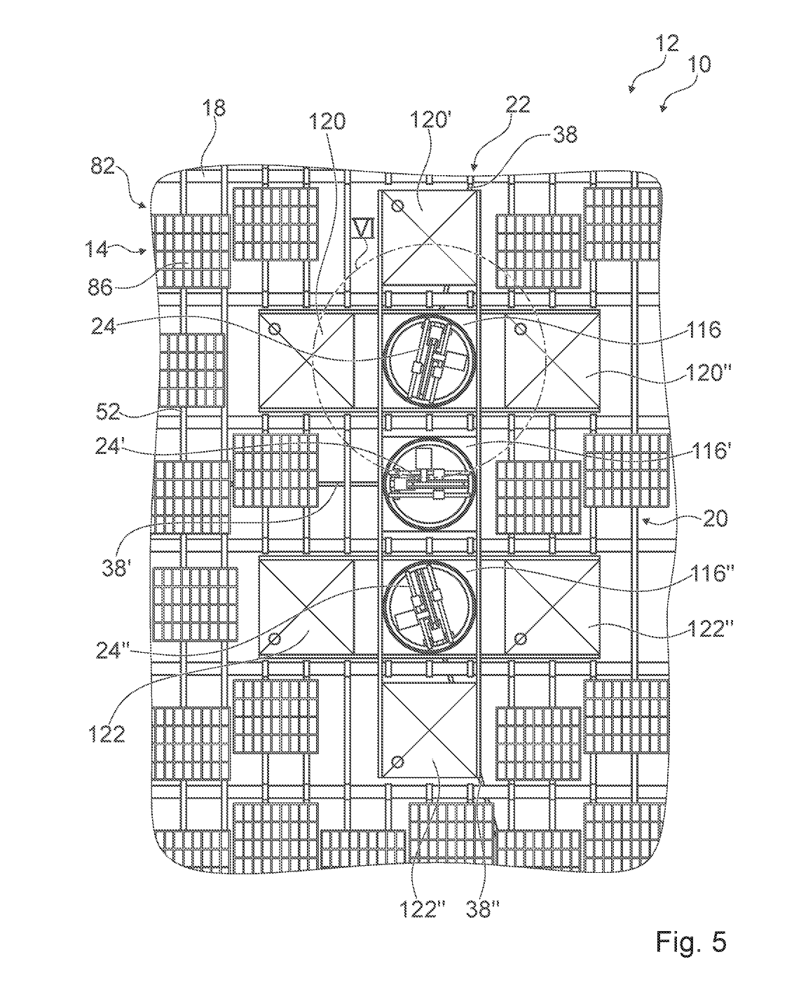

The first anchorage unit 22 comprises three anchor winches 24, 24′, 24″. The second anchorage unit 26 also comprises three anchor winches 28, 28′, 28″. Principally, however, other numbers of anchor winches 24, 24′, 24″, 28, 28′, 28″, which are deemed expedient by a person skilled in the art, would also be conceivable. The anchorage units 22, 26 are embodied identical. The anchorage units 22, 26 merely have a mirror-symmetrical arrangement with respect to each other. The anchorage units 22, 26 are in the following described by way of the first anchorage unit 22. A description of the first anchorage unit 22 may principally also be applied to the second anchorage unit 26 (FIGS. 1, 5).

The anchor winches 24, 24′, 24″ of the first anchorage unit 22 are respectively received in anchor winch receptacles 116, 116′, 116″ of the anchorage unit 22. The anchor winches 24, 24′, 24″ are respectively received in the anchor winch receptacles 116, 116′, 116″ via a ring mount. The anchor winches 24, 24′. 24″ of the first anchorage unit 22 are supported rotatably with respect to the floatable platform 12. The anchor winches 24, 24′, 24″ are supported rotatably about a respective rotary axis 118. The rotary axes 118 of the anchor winches 24, 24′, 24″ extend through a center of the respective anchor winch 24, 24′, 24″. The rotary axes 118 are supported in such a way that they are rotatable perpendicularly to a main extension plane of the platform 12. The anchor winch receptacles 116, 116′, 116″ are arranged in a row one beside the other and are connected via connection carriers. Each of the anchor winch receptacles 116, 116′, 116″ is respectively arranged precisely between two tubes 18. The anchor winch receptacles 116, 116′, 116″ have a square base shape. The first anchor winch receptacle 116 abuts with one side on the second anchor winch receptacle 116′. With its three further sides the anchor winch receptacle 116 abuts on respectively one pontoon 120, 120′, 120″. The three pontoons 120, 120′, 120″ are each embodied as a concrete pontoon. The pontoons 120, 120′. 120″ are respectively implemented by seawater resistant glassfiber-enforced concrete cubes, which are filled with closed-cell foam in safety-relevant places. The three pontoons 120, 120′, 120″ each have a load capacity of approximately 300 tons. Principally, however, a different load capacity would also be conceivable. The anchor winch receptacle 116 is connected to the three pontoons 120, 120′, 120″ via connection carriers. The third anchor winch receptacle 116″ abuts with one side on the second anchor winch receptacle 116′. With its three further sides the anchor winch receptacle 116″ abuts on respectively one pontoon 122, 122′, 122″. The three pontoons 122, 122′, 122″ are each embodied as a concrete pontoon. The pontoons 122, 122′, 122″ are respectively implemented by seawater resistant glassfiber-enforced concrete cubes, which are filled with closed-cell foam in safety-relevant places. The three pontoons 122, 122′, 122″ each have a load capacity of approximately 300 tons. Principally, however, a different load capacity would also be conceivable. The third anchor winch receptacle 116″ is connected to the three pontoons 122, 122′, 122″ via connection carriers. The pontoons 120, 120′, 120″, 122, 122′ 122″ of the anchorage unit 22 provide a buoyant force for the anchorage unit 22. In this the vertical forces are absorbed by the buoyant force of the pontoons 120, 120′, 120″, 122, 122′ 122″, while the horizontal forces are introduced into the operative plane via tie anchors. As the platform 12 is built as a semi-sinker, in particular by way of the tubes 18, and the displacement space of the tubes 18 is designed just so for the platform 12 and the energy generating unit 14, additionally effective forces, e.g. anchoring forces, can be caught up via the pontoons 120, 120′, 120″, 122, 122′ 122″. Principally, it would also be conceivable to provide further pontoons, which, for example, take up rotational forces, a submarine-cable receptacle, landing piers, the staff quarters 80 and/or power processing installations (FIG. 5).

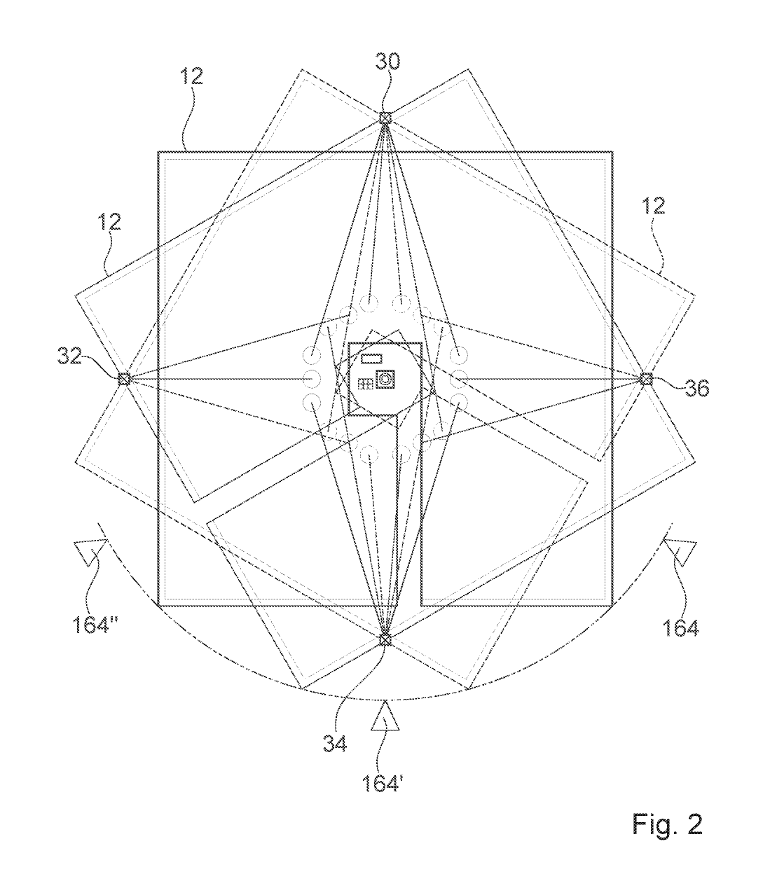

The three anchor winches 24, 24′, 24″ of the first anchorage unit 22 are connected to three anchor points 30, 32, 34, which are embodied spatially separate from each other. Each of the anchor winches 24, 24′, 24″ is connected to respectively one anchor point 30, 32, 34. The first anchor winch 24 is connected to a northern anchor point 30. The second anchor winch 24′ is connected to a western anchor point 32. Furthermore the third anchor winch 24″ is connected to a southern anchor point 34. The three anchor winches 28, 28′, 28″ of the second anchorage unit 26 are also connected to three anchor points 30, 34, 36, which are embodied spatially separate from each other. Each of the anchor winches 28, 28′, 28″ is connected to respectively one anchor point 30, 34, 36. The first anchor winch 28 of the second anchorage unit 26 is connected to the southern anchor point 34. The second anchor winch 28′ is connected to an eastern anchor point 36. Furthermore the third anchor winch 28″ of the second anchorage unit 26 is connected to the northern anchor point 30. The northern anchor point 30 and the southern anchor point 34 are thus connected to respectively two anchor winches 24, 24″, 28, 28″. The anchor winches 24, 24′, 24″ of the first anchorage unit 22 and the anchor winches 28, 28′, 28″ of the second anchorage unit 26 are respectively connected to the anchor points 30, 32, 34, 36 via a spring steel strip 38, 38′, 38″, 40, 40′, 40″. The spring steel strips 38, 38′, 38″, 40, 40′, 40″ each comprise a rectangular cross section with the measuring 2.5 mm×600 mm. A necessary damping of the spring steel strips 38, 38′, 38″, 40, 40′. 40″ is provided in the horizontal orientation of the cross section of the spring steel strips 38, 38′, 38″, 40, 40′, 40″, as the spring steel strips 38, 38′, 38″, 40, 40′, 40″ more or less sag when tensile forces change and this sagging measure may only slowly change under water (FIGS. 1, 2).

The three anchor winches 24, 24′, 24″ of the first anchorage unit 22 and the three anchor winches 28, 28′, 28″ of the second anchorage unit 26 are designed identical. The anchor winches 24, 24′, 24″, 28, 28′, 28″ are in the following described by way of the first anchor winch 24 of the first anchorage unit 22 as an example. A description of the first anchor winch 24 of the first anchorage unit 22 may principally be also applied to the further anchor winches 24′, 24″, 28, 28′, 28″ (FIG. 5).

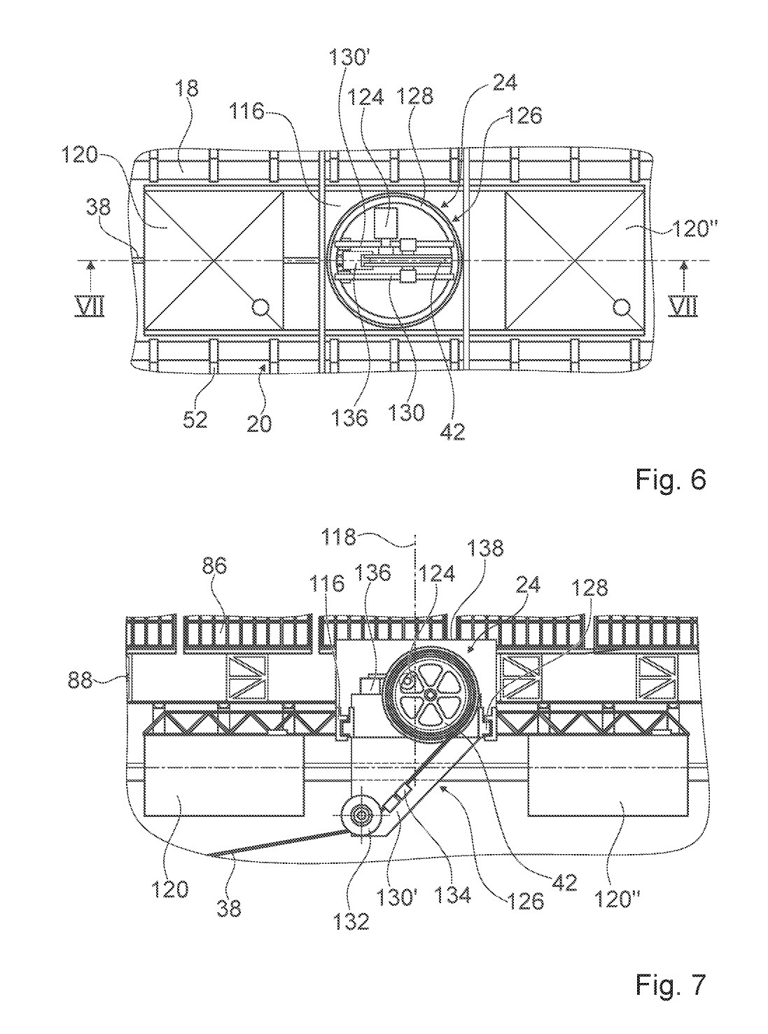

The first anchor winch 24 of the first anchorage unit 22 comprises an anchor wheel 42. The spring steel strip 38 can be wound on the anchor wheel 42 of the anchor winch 24. By winding or unwinding the spring steel strip 38 on the anchor wheel 42 a distance between the anchor winch 24 and the anchor point 30 can be modified. The anchor wheel 42 has a width of a running surface which approximately corresponds to a width of the spring steel strip 38. This allows an even winding and unwinding. The anchor wheel 42 has a diameter of 5 m. A great diameter of the anchor wheel 42 will allow, in particular in case of a large working length of the spring steel strip 38, keeping a diameter increase of the anchor wheel 42 low. As an example, in case of a working length of the spring steel strip 38 of 300 m, a winding package of the spring steel strip 38 on the anchor wheel 42 has a thickness of about 100 mm. The anchor wheel 42 is drivable via a drive unit 124 of the anchor winch 24. The drive unit 124 is embodied as an electromotor. The drive unit 124 comprises a driving cogwheel that cogs a ring gear of the anchor wheel 42. An axis of the drive unit 124 is offset with respect to an axis of the anchor wheel 42. This allows achieving a transmission between the drive unit 124 and the anchor wheel 42 in an advantageously simple fashion. The anchor wheel 42 is received in a base body 126 of the anchor winch 24 in such a way that it is rotatably supported. The drive unit 124 is fixedly connected to the base body 126. The base body 126 comprises a horizontal support ring 128, via which the anchor winch 24 is supported in the ring mount of the anchor winch receptacle 116. The base body 126 further comprises two walls 130, 130′, which extend in parallel to each other and are fixedly connected to the support ring 128. The walls 130, 130′ are oriented vertically. The anchor wheel 42 is partially arranged between the walls 130, 130′. Furthermore a pulley 132 is arranged between the walls 130, 130′. The pulley 132 is arranged approximately on a level with a bottom edge of the pontoons 120, 120′, 120″. The pulley 132 is provided to guide the spring steel strip 38 via the pulley 132 a collision of the spring steel strip 38 with the pontoons 120, 120′, 120″ or with parts of the platform can be prevented. A belt-cleaning unit 134 is arranged between the pulley 132 and the anchor wheel 42. The belt-cleaning unit 134 is also arranged between the walls 130, 130′. The spring steel strip 38 is guided between the pulley 132 and the anchor wheel 42 through the belt-cleaning unit 134. The spring steel strip 38 is cleaned by the belt-cleaning unit 38 before being wound on the anchor wheel 42. Thus, for example, shells or algae can be wiped off before winding the spring steel strip 38 on the anchor wheel 42. Furthermore the anchor winch 24 comprises a brake 136. The brake 136 is provided for blocking the anchor wheel 42. Via the brake 136 the anchor wheel 42 can be stopped, in a state when it is not driven by the drive unit 124, respectively held in its actual position. The anchor winch 24 is partially overlapped by a containment 138. The containment 138 is arranged on the anchor winch receptacle 116. The containment 138 is provided to protect the anchor winch 24 from weather impact (FIGS. 6, 7).

The platform device 10 further comprises a sun position tracking-turning unit 44. The sun position tracking-turning unit 44 is embodied as a computing unit. As an example for quick and easy accessibility, the sun position tracking-turning unit 44 is in this case arranged in the port 74. The sun position tracking-turning unit 44 is provided for a partial sun position tracking and rotating of the floatable platform 12. For a rotating of the floatable platform 12, the sun position tracking-turning unit 44 is provided to actuate the anchor winches 24, 24′, 24″, 28, 28′, 28″ of the first and second anchorage units 22, 26. For a sun position tracking and rotating, the sun position tracking-turning unit 44 is provided to separately actuate the drive units 124 of the anchor winches 24, 24′, 24″, 28, 28′, 28″ and to respectively achieve a rotating of the platform 12 by purposeful winding or unwinding of the spring steel strips 38, 38′, 38″, 40, 40′, 40″. Thus a rotation by 120° is achievable. The platform 12 can thus be oriented towards the sun from 8 am in the morning to 4 pm in the afternoon. The rotation is effected in this case with a force of 100 tons per anchorage unit 22, 26, which has to be absorbed in addition to the anchor forces. As a rotation is effected very slowly (in the present case there are 300 m of spring steel strip 38, 38′, 38″, 40, 40′, 40″ which have to be wound and unwound within 8.0 hrs), this can be done at a comparably low power input. The power required for the rotation is less than 1% of a power generated by the energy generating unit 14. In case of a water depth of more than 300 m, it would be also conceivable to implement a rotation back from the 4 pm position to the 8 am position by means of a weight of e.g. respectively 100 tons, which is pulled up during the day. In this way a rotation back could be effected overnight without energy input from the mainland (FIGS. 1, 2).

As the platform orients itself according to the sun position, the shadow of the windwheels 90 is always in the same place, due to which no photovoltaic modules 86 are mounted in that area.

In FIG. 2 the platform 12 is shown in three different rotary positions at three different sun positions 164, 164′, 164″. The platform 12 is herein shown just schematically in the respective rotary positions. A first sun position 164 herein corresponds to an 8 am rotary position of the platform 12. In this rotary position the platform 12 is depicted by dashed lines. A second sun position 164′ herein corresponds to a 12 am rotary position of the platform 12. In this rotary position the platform 12 is depicted by a continuous line. A third sun position 164″ herein corresponds to a 4 pm rotary position of the platform 12. In this rotary position the platform 12 is depicted by a dot-and-dash line. The floatable platform 12 is rotated via the sun position tracking-turning unit 44 with respect to a sun position partially by means of the anchorage units 22, 26.

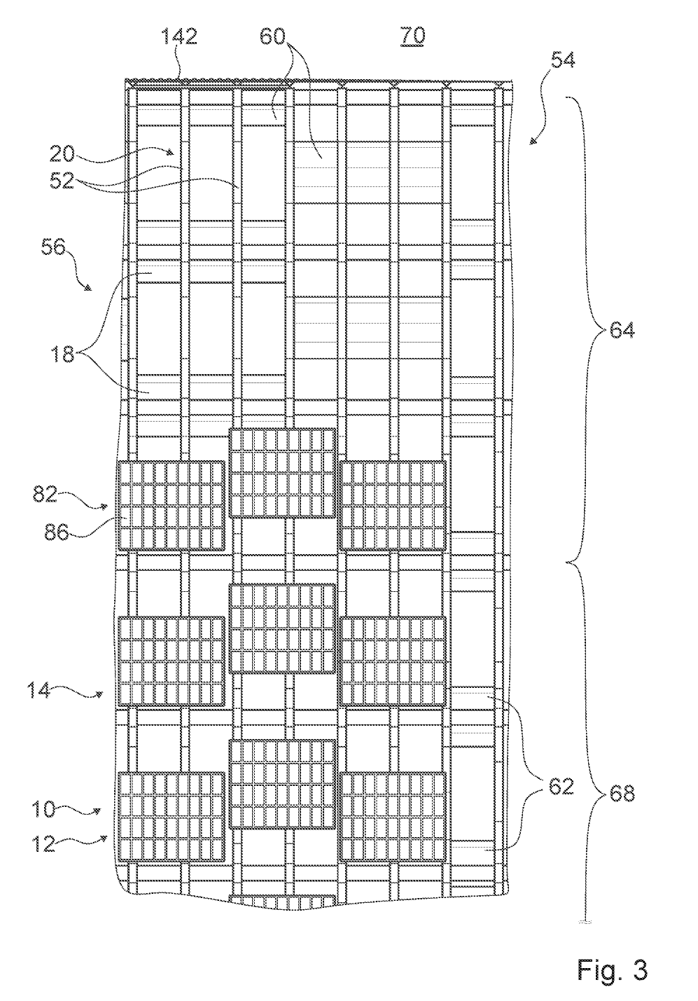

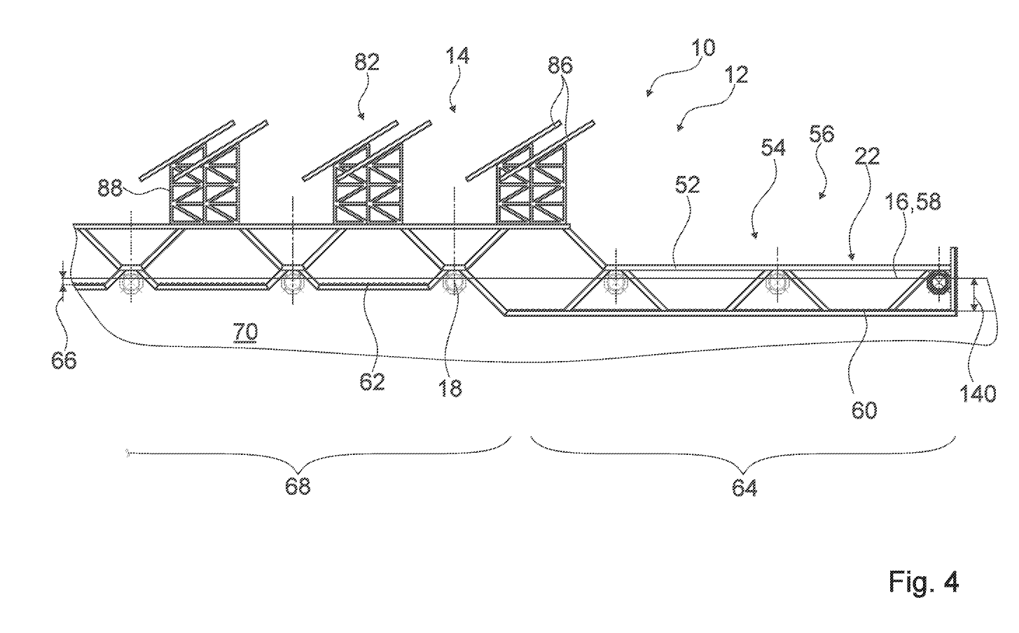

The floatable platform 12 comprises in a peripheral edge region 54 a breakwater device 56. The breakwater device 56 comprises a plurality of structural elements 60, 62, which are arranged below a water surface 58. The structural elements 60, 62 are arranged in parallel to the main extension plane of the platform 12. The structural elements 60, 62 of the breakwater device 56 are each embodied as a trapezoidal sheet. The structural elements 60, 62 are arranged in such a way that they are distributed over a peripheral edge region 54. The structural elements 60, 62 are further provided for delaying a wave. The structural elements 60, 62 are provided for delaying waves hitting on the platform 12. The structural elements 60, 62 are fixated on the carrier structure 20 of the platform 12. The breakwater device 56 herein comprises a plurality of first structural elements 60. The first structural elements 60 are arranged in an outer peripheral edge region 64. The first structural elements 60 are arranged offset to each other in a plane parallel to a main extension plane of the platform 12. The breakwater device 56 furthermore comprises a plurality of second structural elements 62. The second structural elements 62 are arranged in an inner peripheral edge region 68. The second structural elements 62 are arranged offset to each other in a plane parallel to a main extension plane of the platform 12. The second structural elements 62 are arranged at a substantially smaller depth 66 below a water surface 58 than the first structural elements 60. The first structural elements 60 are arranged at a depth 140 of about 2.5 m. In contrast, the second structural elements 62 are arranged at a depth 66 of about 1.0 m. Therefore, in the outer peripheral edge region 64, waves are delayed by the first structural elements 60 at a bottom and are thus induced to turn over. In the following phase in the inner peripheral edge region 68 the new, smaller waves originating from the big waves are delayed once again by the second structural elements 62 and are broken again. The breakwater device 56 causes a delay of waves hitting on the platform device 10 in a peripheral edge region 54 of the floatable platform 12 (FIGS. 3, 4).

Furthermore, a portion of the tubes 18 of the floatable platform 12 implements a portion of the breakwater device 56 of the floatable platform 12. The tubes 18 that are arranged in the peripheral edge region 54 form a portion of the breakwater device 56.

In this way, in the peripheral edge region 54 consisting of the outer peripheral edge region 64 and the inner peripheral edge region 68, a wave pattern is generated that has no negative impact on the platform 12. At a distance of about 100 m (measured from an outer edge of the platform 12), there is only an unsubstantial swell, as a result of which all components, e.g. the pontoons 120, 120′, 120″, 122, 122′, 122″, the submarine cable 78, etc. can be dimensioned without considering waves. Rare big waves will generate waves towards the interior but will not cause damages as the platform 12 offers little resistance due to the carrier structure 20 and just lets the rare big waves pass. Seaworthiness is thus ensured up to a wave height of 14.0 m.

Moreover the platform 12 comprises a flotsam rejecter 142 in the peripheral edge region 54, at an extreme edge. The flotsam rejecter 142 is embodied as a water-permeable, in particular perforated, sheet that is arranged on a level with the water level 16. The flotsam rejecter 142 is arranged on a level of the tubes 18. Principally, however, another implementation deemed expedient by a person skilled in the art would also be conceivable, for example as a net. The flotsam rejecter 142 is vertically fixated to the carrier structure 20. The flotsam rejecter 142 is arranged all around the edge of the platform 12. By way of the flotsam rejecter 142, flotsam is to be prevented from getting in (FIGS. 3, 4).

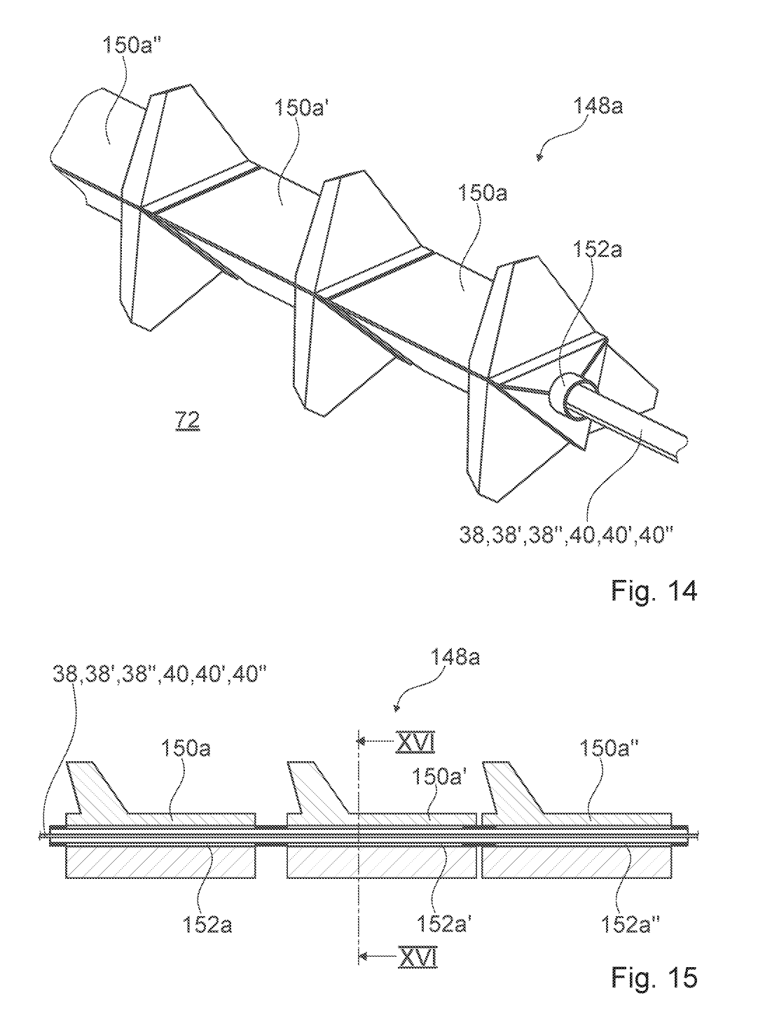

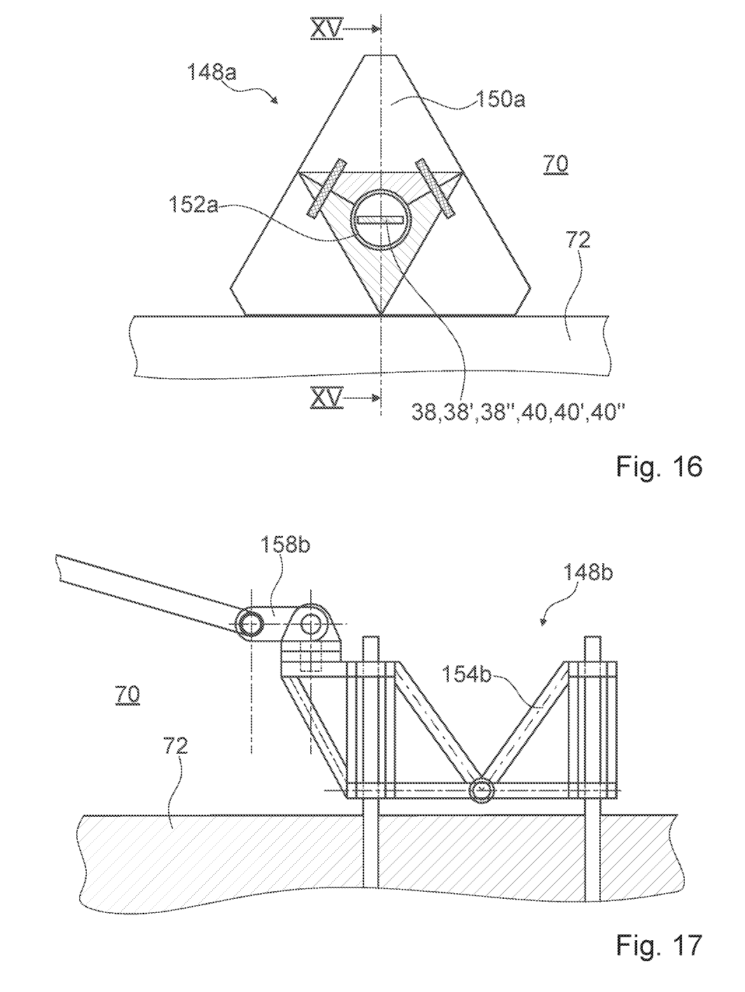

The spring steel strips 38, 38′, 38″, 40, 40′, 40″ are fixated on the sea bottom 72 at the anchor points 30, 32, 34, 36 respectively via a bottom anchorage 148a. In this an implementation of the bottom anchorage 148a depends on properties and condition of the sea bottom 72, a water depth and official environmental requirements. The bottom anchorage 148a of the present embodiment comprises a plurality of pre-fabricated concrete parts 150a, 150a′, 150a″. The bottom anchorage 148a is expedient in particular in case of great water depths. The pre-fabricated concrete parts 150a, 150a′, 150a″ each comprise an integrated tube 152a, 152a′, 152a″, in which the respective spring steel strip 38, 38′, 38″, 40, 40′, 40″ may be guided respectively. The tube 152a, 152a′, 152a″ is embodied as a PP tube. The pre-fabricated concrete parts 150a, 150a′, 150a″ can each be parted and are screwed via bolts in such a way that the tube 152a, 152a′, 152a″ can be opened sideways. In this way, for example on a work boat, the spring steel strip 38, 38′, 38″, 40, 40′, 40″ can be threaded through the pre-fabricated concrete part 150a, 150a′, 150a″ to allow putting out the pre-fabricated concrete part 150a, 150a′, 150a″ in such a way that it is guided along the spring steel strip 38, 38′, 38″, 40, 40′, 40″. The pre-fabricated concrete parts 150a, 150a′, 150a″ of an anchor point 30, 32, 34, 36 are respectively connected to each other in a form-fit and force-fit manner. When one of the anchor points 30, 32, 34, 36 is set, the spring steel strip 38, 38′, 38″, 40, 40′. 40″ is sunk at the intended place with an end terminal (not shown in detail). Following this the pre-fabricated concrete parts 150a, 150a′, 150a″ are sunk on the spring steel strip 38, 38′, 38″, 40, 40′, 40″—like on a pearl string—in a calculated number (FIGS. 14, 15, 16).

In FIGS. 17 to 19 two further exemplary embodiments of a bottom anchorage of the invention are shown. The following descriptions are substantially restricted to the implementation of the bottom anchorage, wherein the description of the other exemplary embodiments, in particular of FIGS. 1 to 16, may be referred to regarding components, features and functions that remain the same. For distinguishing the exemplary embodiments, the letter a in the reference numerals of the bottom anchorage of the exemplary embodiment of FIGS. 1 to 16 has been replaced by the letters b and c in the reference numerals of the bottom anchorage of the exemplary embodiments of FIGS. 17 to 19. Regarding components with equal denominations, in particular regarding components with the same reference numerals, principally the drawings and/or the description of the other exemplary embodiments, in particular of FIGS. 1 to 16, may be referred to.

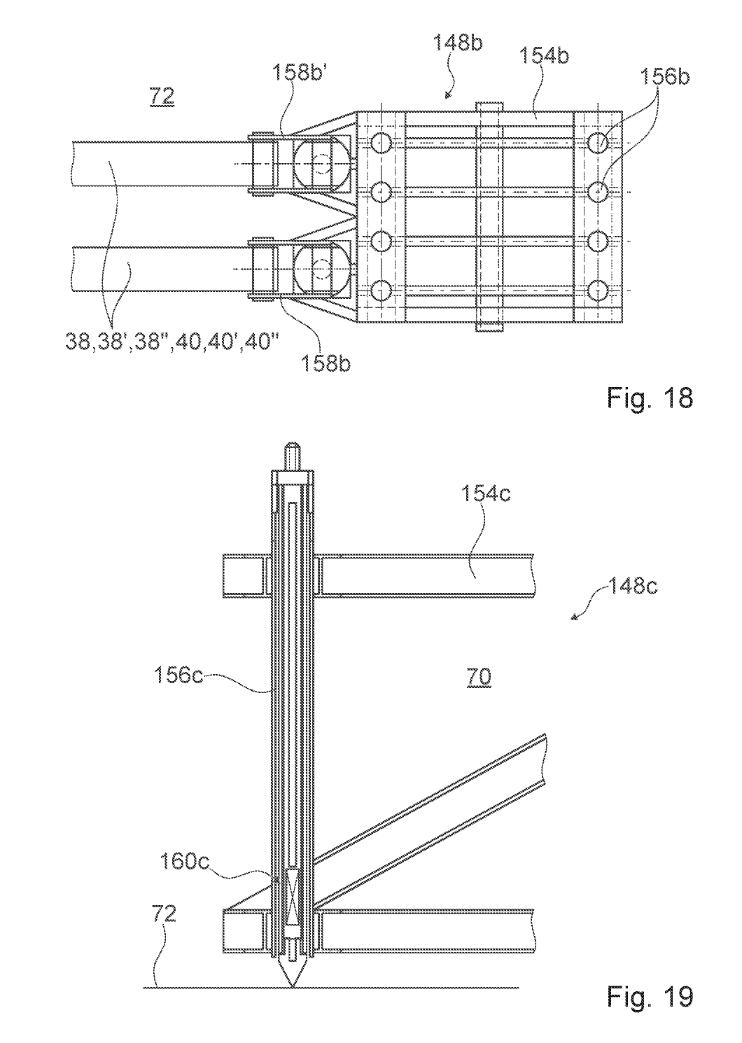

FIG. 17 shows an alternative bottom anchorage 148b of the platform device 10. The spring steel strips 38, 38′, 38″, 40, 40′, 40″ are fixated on the sea bottom 72 at the anchor points 30, 32, 34, 36 respectively via the bottom anchorage 148b. The bottom anchorage 148b comprises an anchor bracket 154b. The anchor bracket 154b is embodied by IPE profiles. The anchor bracket 154b comprises a mask with a given number of recesses. Anchor piles 156b of a given length are respectively guided through the recesses and fixated. The anchor piles 156b are embodied as Larssen profiles. Larssen profiles are expedient in particular in case of soft sediments. The spring steel strips 38, 38′, 38″, 40, 40′, 40″ are fastened to the anchor bracket 154b via pivot joints 158b, 158b′. The anchor piles 156b are sunk into a sea bottom 72 via a blow drive or vibration drive comprising a pressure-resistant casing. The construction is selected in such a way that no underwater work is required. When setting one of the anchor points 30, 32, 34, 36, a guest rope is sunk as well, by means of which the spring steel strip 38, 38′, 38″, 40, 40′, 40″ can be pulled in and fastened to a docking buoy (FIGS. 17, 18).

FIG. 19 shows another alternative bottom anchorage 148c of the platform device 10. The spring steel strips 38, 38′, 38″, 40, 40′, 40″ are fixated on the sea bottom 72 at the anchor points 30, 32, 34, 36 respectively via the bottom anchorage 148c. The bottom anchorage 148c comprises an anchor bracket 154c. The anchor bracket 154c is implemented by IPE profiles. The anchor bracket 154c comprises a mask with a given number of recesses. Anchor piles 156c of a given length are respectively guided through the recesses and fixated. The anchor piles 156c are embodied as drill piles. Drill piles are expedient in particular in case of hard sediment. The anchor piles 156c respectively comprise an ignition device 160c. The spring steel strips 38, 38′, 38″, 40, 40′, 40″ are fastened to the anchor bracket 154c via pivot joints.

1. A platform device with at least one floatable platform, which is provided for supporting at least one energy generating unit at least partially above a water level, wherein
the at least one floatable platform comprises a plurality of tubes providing a buoyant force and comprises a carrier structure, which is fastened to the tubes.

2. The platform device according to claim 1, comprising at least one first anchorage unit, which is stationarily connected to the at least one floatable platform and comprises at least one anchor winch.

3. The platform device according to claim 2, comprising at least one second anchorage unit, which is stationarily connected to the at least one floatable platform and comprises at least one anchor winch.

4. The platform device according to claim 2, wherein the at least one anchorage unit comprises at least two anchor winches, which are connected to at least two anchor points that are embodied spatially separate from each other.

5. The platform device according to claim 2, wherein the at least one anchor winch of the at least one anchorage unit is supported rotatably with respect to the at least one floatable platform.

6. The platform device according to claim 2, wherein the at least one anchor winch of the at least one anchorage unit is connected to an anchor point via a spring steel strip.

7. The platform device according to claim 6, wherein the at least one anchor winch of the at least one anchorage unit comprises at least one anchor wheel, on which the spring steel strip can be wound at least partially.

8. The platform device according to claim 1, comprising a sun position tracking-turning unit, which is provided for an at least partial sun position tracking and rotating of the at least one floatable platform.

9. The platform device at least according to claim 2, wherein the sun position tracking-turning unit that is intended for rotating the at least one floatable platform is provided for actuating the at least one anchor winch of the at least one anchorage unit.

10. The platform device according to claim 1, wherein the tubes of the at least one floatable platform each comprise at least three spigots, which are embodied in a one-part implementation with a base body of the tube and are respectively provided for receiving a fastening element.

11. The platform device according to claim 10, wherein the carrier structure, which is at least partially fastened to the fastening elements, is implemented at least partially by trapezoid profiles.

12. The platform device according to claim 1, wherein the at least one floatable platform comprises in a peripheral edge region a breakwater device with at least one structural element that is arranged below a water surface and is provided for delaying a wave.

13. The platform device according to claim 12, wherein the at least one structural element of the breakwater device is embodied as a trapezoidal sheet.

14. The platform device according to claim 12, wherein the breakwater device comprises at least one first structural element arranged in an outer peripheral edge region and comprises at least one second structural element arranged at a substantially smaller depth below the water surface than the first structural element and arranged in an inner peripheral edge region.

15. The platform device according to claim 12, wherein at least a portion of the tubes of the at least one floatable platform is embodied as semi-sinkers, implementing a portion of the breakwater device of the at least one floatable platform.

16. A method for operating a platform device according to claim 1.

17. The method according to claim 16, wherein the at least one floatable platform is rotated via the sun position tracking-turning unit at least partially with respect to a sun position by means of the at least one anchorage unit.

18. The method according to claim 16, wherein the breakwater device induces at least in a peripheral edge region of the floatable platform a delay of waves hitting on the platform device.
